(19) United States
(12) Patent Application Publication
(10) Pub. No.: US 2009/0259399 A1
(43) Pub. Date: Oct. 15, 2009

(54) Obstacle detection method and system

(75) Inventors: Badari Kotejoshyer, Bangalore (IN); David Edwards, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/081,346

(22) Filed: Apr. 15, 2008

(51) Int. Cl. G08G 1/00

(52) U.S. Cl. 701/300

(57) ABSTRACT

A system for detecting obstacles near a machine is disclosed. The system has a plurality of obstacle sensors located on the machine. The system also has a controller in communication with each of the plurality of obstacle sensors. The controller is configured to pair one-to-one each of the plurality of obstacle sensors to each of a plurality of non-overlapping confidence regions. Additionally, the controller is configured to scan with the plurality of obstacle sensors. The controller is also configured to receive from the plurality of obstacle sensors raw data regarding the scanning, and assemble the raw data into a map. Based on the map, the controller is configured to determine at least one characteristic of at least one obstacle.

### TECHNICAL FIELD

The present disclosure relates generally to a detection method and, more particularly, to a method for detecting obstacles near a machine.

### BACKGROUND

Large machines such as, for example, wheel loaders, off-highway haul trucks, excavators, motor graders, and other types of earth-moving machines are used to perform a variety of tasks. Some of these tasks involve intermittently moving between and stopping at certain locations within a worksite and, because of the poor visibility provided to operators of the machines, these tasks can be difficult to complete safely and effectively. Therefore, operators of the machines may additionally be provided with detections of obstacle sensors. But, individual obstacle sensors operate effectively (i.e. provide accurate detections) only within certain spatial regions. Outside of these regions, the obstacle sensors may provide inaccurate detections. For example, one obstacle sensor may detect an obstacle at a certain location, and another obstacle sensor may detect nothing at that same location, solely because of how each is mounted to the machine and aimed.

One way to minimize the effect of these contradictory detections is described in U.S. Pat. No. 6,055,042 (the '042 patent) issued to Sarangapani on Apr. 25, 2000. The '042 patent describes a method for detecting an obstacle in the path of a mobile machine. The method includes scanning with each of a plurality of obstacle sensor systems. The method also includes weighting the data scanned by each of the obstacle sensor systems based upon external parameters such as ambient light, size of the obstacle, or amount of reflected power received from the obstacle. Based on this weighted data, at least one characteristic of the obstacle is determined.

Although the method of the '042 patent may improve detection of an obstacle in the path of a mobile machine, it may be prohibitively expensive for certain applications. In particular, weighting the data scanned by the obstacle sensor systems may be unnecessary. Because this weighting may require information regarding external parameters, additional hardware may be required. And, this additional hardware may increase the costs of implementing the method.

The disclosed method and system are directed to overcoming one or more of the problems set forth above.

### SUMMARY

In one aspect, the present disclosure is directed to a method for detecting obstacles near a machine. The method includes pairing one-to-one each of a plurality of obstacle sensors to each of a plurality of non-overlapping confidence regions. Additionally, the method includes scanning with the plurality of obstacle sensors. The method also includes receiving from the plurality of obstacle sensors raw data regarding the scanning. In addition, the method includes assembling the raw data into a map. The method also includes determining at least one characteristic of at least one obstacle, based on the map.

In another aspect, the present disclosure is directed to a system for detecting obstacles near a machine. The system includes a plurality of obstacle sensors located on the machine. The system also includes a controller in communication with each of the plurality of obstacle sensors. The controller is configured to pair one-to-one each of the plurality of obstacle sensors to each of a plurality of non-overlapping confidence regions. Additionally, the controller is configured to scan with the plurality of obstacle sensors. The controller is also configured to receive from the plurality of obstacle sensors raw data regarding the scanning, and assemble the raw data into a map. Based on the map, the controller is configured to determine at least one characteristic of at least one obstacle.

### BRIEF DESCRIPTION OF THE DRAWINGS

FIG. 1 is a pictorial illustration of an exemplary disclosed machine;

FIG. 2 is a diagrammatic illustration of an exemplary disclosed obstacle detection system for use with the machine of FIG. 1;

FIG. 3 is a pictorial illustration of exemplary disclosed coordinate systems for use with the obstacle detection system of FIG. 2;

FIG. 4 is a top view of exemplary disclosed detection regions for use with the obstacle detection system of FIG. 2;

FIG. 5 is a front view of exemplary disclosed confidence regions within the detection regions of FIG. 4; and

FIG. 6 is a flow chart describing an exemplary method of operating the obstacle detection system of FIG. 2.

### DETAILED DESCRIPTION

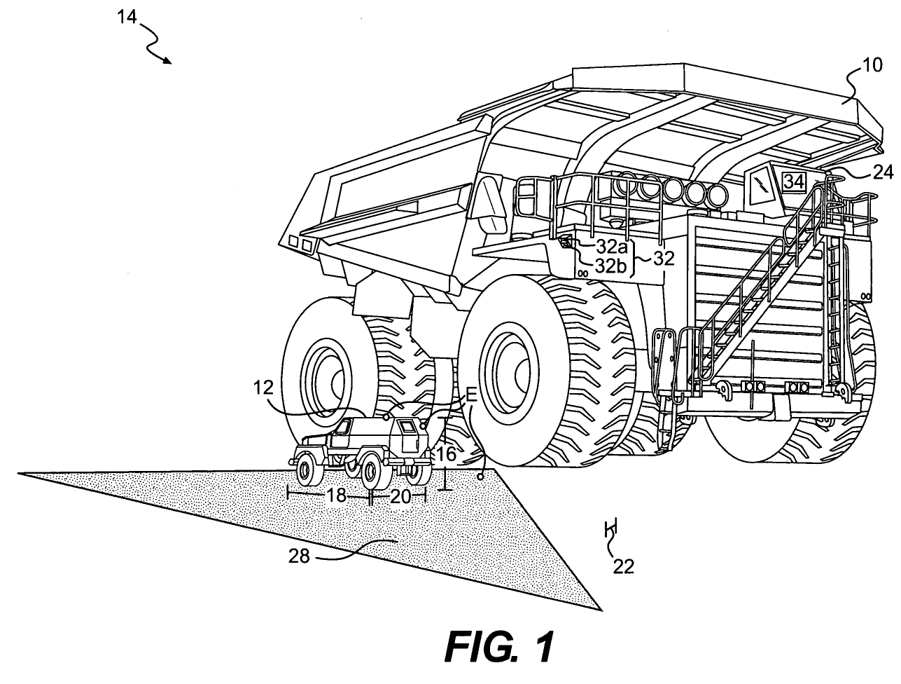

FIG. 1 illustrates an exemplary machine 10 and an obstacle 12 of machine 10, both located at a worksite 14. Although machine 10 is depicted as an off-highway haul truck, it is contemplated that machine 10 may embody another type of large machine, for example, a wheel loader, an excavator, or a motor grader. Obstacle 12 is depicted as a service vehicle. But, it is contemplated that obstacle 12 may embody another type of obstacle, for example, a pick-up truck, or a passenger car. If obstacle 12 is at least a certain size, obstacle 12 may be classified as dangerous. For example, the certain size may be a length 22. If obstacle 12 has a height 16 longer than a length 22, a width 18 longer than length 22, or a depth 20 longer than length 22, obstacle 12 may be classified as dangerous. Worksite 14 may be, for example, a mine site, a landfill, a quarry, a construction site, or another type of worksite known in the art.

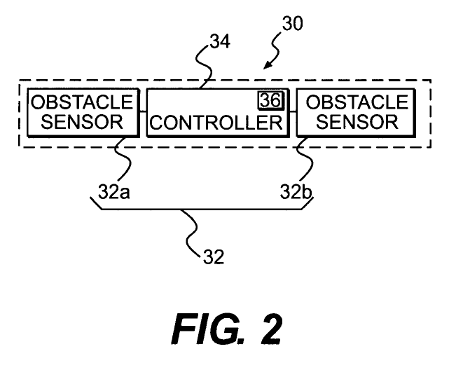

Machine 10 may have an operator station 24, which may be situated to minimize the effect of blind spots (i.e. maximize the unobstructed area viewable by an operator of machine 10). But, because of the size of some machines, these blind spots may still be large. For example, dangerous obstacle 12 may reside completely within a blind spot 28 of machine 10. To avoid collisions with obstacle 12, machine 10 may be equipped with an obstacle detection system 30 (referring to FIG. 2) to gather information about obstacles 12 within blind spot 28.

Obstacle detection system 30 may include an obstacle sensor 32, or a plurality thereof to detect points E on surfaces within blind spot 28. For example, obstacle detection system 30 may include a first obstacle sensor 32a and a second obstacle sensor 32b. Obstacle sensor 32a may detect points E₁ that are on surfaces facing it (i.e. points E within a line of sight of obstacle sensor 32a). And, obstacle sensor 32b may detect points E₂ that are on surfaces facing it (i.e. points E within a line of sight of obstacle sensor 32b). Detections of points E₁ and E₂ may be raw (i.e. not directly comparable). Therefore, as illustrated in FIG. 2, obstacle detection system 30 may also include a controller 34, which may receive communications including the detections of points E₁ and E₂ from obstacle sensors 32a and 32b, respectively, and then transform, filter, and/or unionize the detections.

Controller 34 may be associated with operator station 24 (referring to FIG. 1), or another protected assembly of machine 10. Controller 34 may include means for monitoring, recording, storing, indexing, processing, and/or communicating information. These means may include, for example, a memory, one or more data storage devices, a central processing unit, and/or another component that may transform, filter, and/or unionize detections of points E₁ and E₂. In particular, controller 34 may include or be configured to generate a map 36 to store the locations of transformed points E₁ and E₂. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

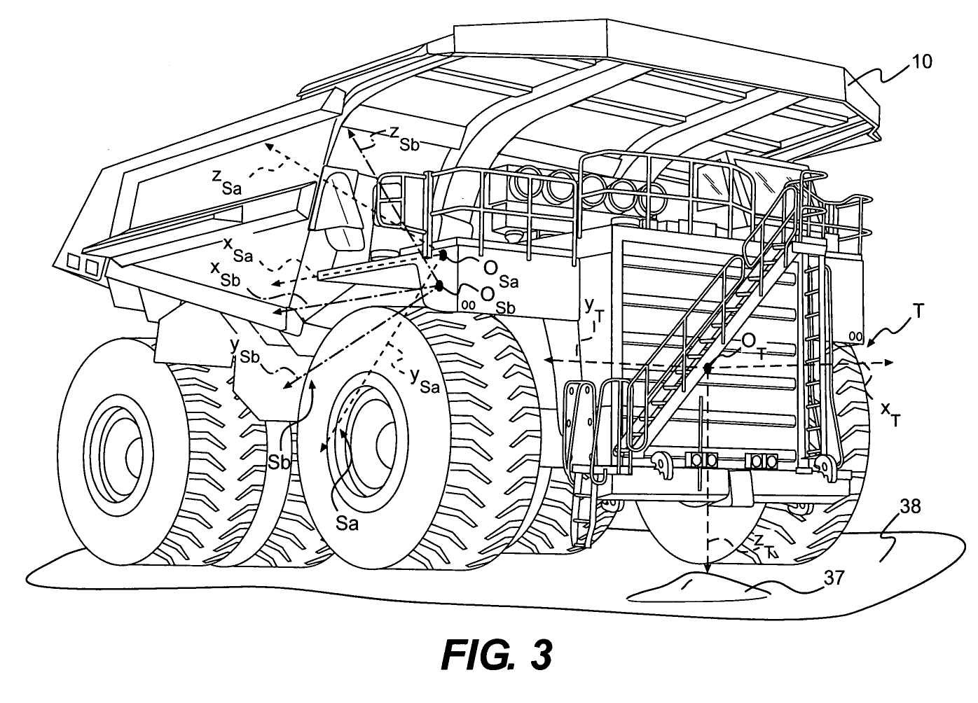

Map 36, electronic in form, may be stored in the memory of controller 34, and may be updated in real time to reflect the locations of transformed points E₁ and E₂. As illustrated in FIG. 3, these locations may be defined with respect to a coordinate system T. Coordinate system T may have an origin at a point O_{T}, which may be fixedly located with respect to machine 10. Coordinate system T may be a right-handed 3-D cartesian coordinate system having axis vectors x_{T}, y_{T}, and z_{T}. It is contemplated that axis vector z_{T} may extend gravitationally downward from point O_{T} toward a ground surface 37 when machine 10 is in an upright position. Therefore, a plane formed by axis vectors x_{T} and y_{T} may be substantially parallel to a predicted ground surface 38. A point in coordinate system T may be referenced by its spatial coordinates in the form X_{T}=[t₁ t₂ t₃], where from point O_{T}, t₁ is the distance along axis vector x_{T}, t₂ is the distance along axis vector y_{T}, and t₃ is the distance along axis vector z_{T}. An orientation with respect to coordinate system T may be referenced by its angular coordinates in the form A_{T}=[t₄ t₅ t₆], where rotated about point O_{T}, t₄ is the pitch angle (i.e. rotation about axis vector y_{T}), t₅ is the yaw angle (i.e. rotation about axis vector z_{T}), and t₆ is the roll angle (i.e. rotation about axis vector x_{T}).

As previously discussed, detections of points E₁ and E₂ by obstacle sensors 32a and 32b, respectively, may be raw. In particular, these detections may be raw because sensors 32a and 32b may or may not be fixedly located at a shared location with respect to coordinate system T. For example, it is contemplated that obstacle sensors 32a and 32b may both be attached to a quarter panel 39 of machine 10, but obstacle sensor 32a may be located at a point O_{Sa} and obstacle sensor 32b may be located at a point O_{Sb}. Therefore, locations of points E₁ may be detected with respect to a coordinate system Sa, with an origin at point O_{Sa}, and locations of points E₂ may be detected with respect to a coordinate system Sb, with an origin at point O_{Sb}.

Coordinate system Sa may be a right-handed 3-D cartesian coordinate system having axis vectors x_{Sa}, y_{Sa}, and z_{Sa}. A point in coordinate system Sa may be referenced by its spatial coordinates in the cartesian form X_{Sa}=[sa₁ sa₂ sa₃], where from point O_{Sa}, sa₁ is the distance along axis vector x_{Sa}, sa₂ is the distance along axis vector y_{Sa}, and sa₃ is the distance along axis vector z_{Sa}. The geographical location of point O_{Sa} and the orientation of coordinate system Sa relative to coordinate system T may be fixed and known. In particular, X_{T}(O_{Sa}) may equal [−b_{Sa1} −b_{Sa2} −b_{Sa3}], and A_{T}(Sa) may equal [psa ysa rsa]. A point in coordinate system Sa may alternatively be referenced by its spatial coordinates in the polar form X_{SaP}=[ρa θa φa], where ρa is the distance from point O_{Sa}, θa is the polar angle from axis vector x_{Sa}, and φa is the zenith angle from axis vector z_{Sa}.

Coordinate system Sb may be a right-handed 3-D cartesian coordinate system having axis vectors x_{Sb}, y_{Sb}, and z_{Sb}. A point in coordinate system Sb may be referenced by its spatial coordinates in the cartesian form X_{Sb}=[sb₁ sb₂ sb₃], where from point O_{Sb}, sb₁ is the distance along axis vector x_{Sb}, sb₂ is the distance along axis vector y_{Sb}, and sb₃ is the distance along axis vector z_{Sb}. The geographical location of point O_{Sb} and the orientation of coordinate system Sb relative to coordinate system T may also be fixed and known. In particular, X_{T}(O_{Sb}) may equal [−b_{Sb1} −b_{Sb2}−b_{Sb3}], and A_{T} (Sb) may equal [psb ysb rsb]. A point in coordinate system Sb may alternatively be referenced by its spatial coordinates in the polar form X_{SbP}=[ρb θb φb], where ρb is the distance from point O_{Sb}, θb is the polar angle from axis vector x_{Sb}, and φb is the zenith angle from axis vector z_{Sb}.

Each obstacle sensor 32 may embody a LIDAR (light detection and ranging) device, a RADAR, (radio detection and ranging) device, a SONAR (sound navigation and ranging) device, a vision based sensing device, or another type of device that may detect a range and a direction to points E. For example, as detected by obstacle sensor 32a, the range to point E₁ may be represented by spatial coordinate ρa and the direction to point E₁ may be represented by the combination of spatial coordinates θa and φa. And, as detected by obstacle sensor 32b, the range to point E₂ may be represented by spatial coordinate ρb and the direction to point E₂ may be represented by the combination of spatial coordinates θb and φb.

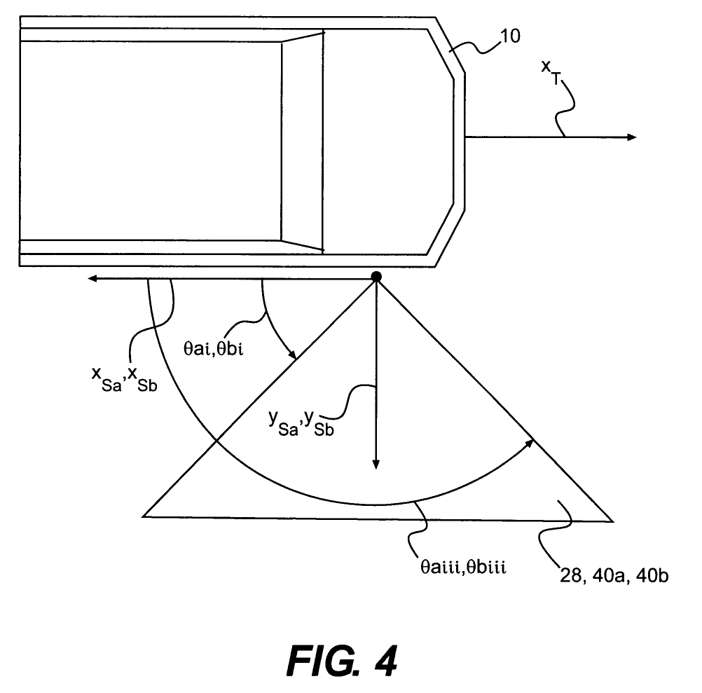

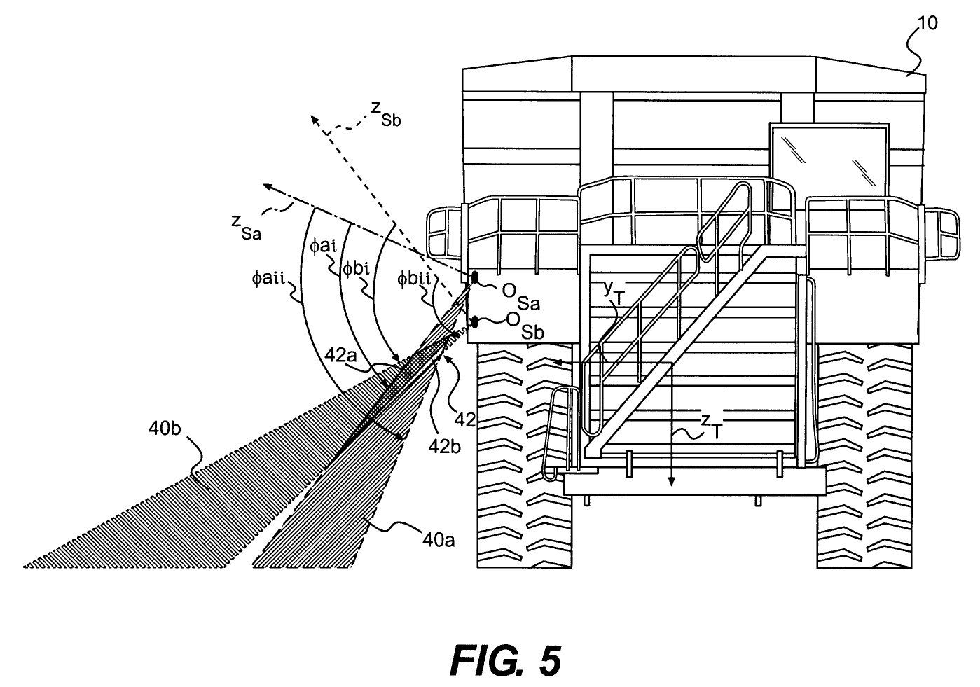

As illustrated in FIGS. 4 and 5, the detections made by obstacle sensors 32a and 32b may be bounded by certain spatial coordinates, thereby forming detection regions 40a and 40b, respectively. For example, detection region 40a may be bounded by θa=θai and θa=θaii, and by φa=φai and φa=φaii. And, detection region 40b may be bounded by θb=θbi and θb=θbii, and by φb=φbi and φb=φbii. It is contemplated that detection regions 40a and 40b may overlap at an over-detected region 42 (shown by double crosshatching and shading in FIG. 5).

Some of the detections within over-detected region 42 may be inaccurate due to reflections or other unknown interferences. For example, detections of points E₁ within over-detected region 42a (shown by double crosshatching in FIG. 5), and detections of points E₂ within over-detected region 42b (shown by shading in FIG. 5) may be inaccurate. But, the reverse may not be true. That is, detections of points E₂ within over-detected region 42a may be accurate, and detections of points E₁ within over-detected region 42b may be accurate. Therefore, it is contemplated that, as previously discussed and as described below, controller 34 may transform, filter, and unionize the detections of points E₁ and E₂ to remove inaccurate detections.

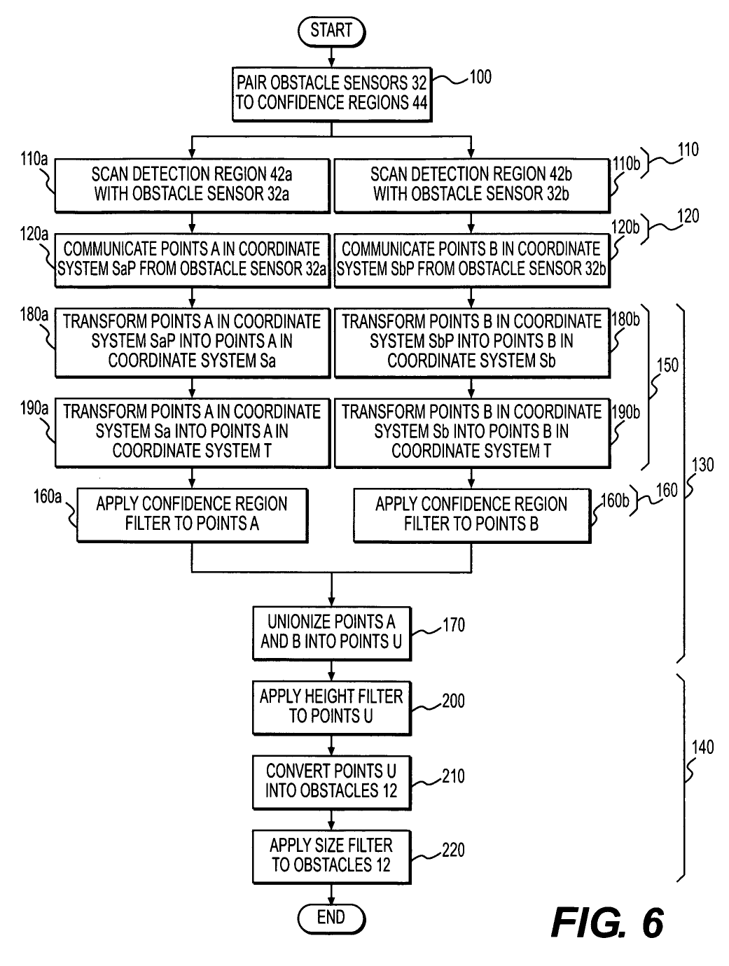

FIG. 6 illustrates an exemplary method of operating the disclosed system. FIG. 6 will be discussed in the following section to further illustrate the disclosed system and its operation.

### INDUSTRIAL APPLICABILITY

The disclosed system may be applicable to machines, which may intermittently move between and stop at certain locations within a worksite. The system may determine a characteristic of an obstacle near one of the machines. In particular, the system may detect and analyze surface points to determine the size and location of the obstacle. Operation of the system will now be described.

As illustrated in FIG. 6, the disclosed system, and more specifically, controller 34, may pair each obstacle sensor 32 to a confidence region 44 (step 100). Each obstacle sensor 32 may scan (i.e. detect points E within) its associated detection region 42 (step 110), and communicate data regarding these scans (i.e. the raw locations of points E) to controller 34 (step 120). Based on the pairings of step 100, controller 34 may assemble the raw locations of points E into map 36 (step 130). Controller 34 may then, based on map 36, determine a characteristic of at least one obstacle (step 140).

The pairing of step 100 may be based on the location and orientation of obstacle sensors 32a and 32b. Since the pairing is one-to-one, controller 34 may use it to resolve conflicting obstacle detections from sensor 32a and 32b. For example, obstacle sensor 32a may be paired with confidence region 44a, which may include the volume bounded by detection region 40a (referring to FIG. 5) except for that volume also bounded by over-detected region 42a (referring to FIG. 5). Obstacle sensor 32b may be paired with confidence region 44b, which may include the volume bounded by detection region 40b except for that volume also bounded by over-detected region 42b. It is contemplated that an operator of machine 10 may define the volumes bounded by detection regions 40 and over-detected regions 42. Alternatively, it is contemplated that the operator of machine 10 may define directly the volumes bounded by confidence regions 44.

Before or after step 100, each obstacle sensor 32 may scan its associated detection region 42 (step 110). As previously discussed, each obstacle sensor 32 may detect the range and direction from itself to points E. It is contemplated that these detections may occur concurrently (i.e. parallelly). For example, obstacle sensor 32a may detect the range and direction from itself to points E₁ (step 110a). And, obstacle sensor 32b may detect the range and direction from itself to points E₂ (step 110b).

Each of obstacle sensors 32a and 32b may then simultaneously communicate to controller 34 several points E₁ (step 120a) and several points E₂ (step 120b), respectively. For example, obstacle sensor 32a communications may include the locations of n points E₁ in coordinate system Sa in polar form:

$${X}_{SaP} = [ \begin{matrix}ρ {a}_{1} & θ {a}_{1} & ϕ {a}_{1} \\ ρ {a}_{2} & θ {a}_{2} & ϕ {a}_{2} \\ ⋮ & ⋮ & ⋮ \\ ρ {a}_{n} & θ {a}_{n} & ϕ {a}_{n}\end{matrix} ] ,$$

each row representing one point. And, obstacle sensor 32b communications may include the locations of n points E₂ in coordinate system Sb in polar form:

$${X}_{SbP} = [ \begin{matrix}ρ {b}_{1} & θ {b}_{1} & ϕ {b}_{1} \\ ρ {b}_{2} & θ {b}_{2} & ϕ {b}_{2} \\ ⋮ & ⋮ & ⋮ \\ ρ {b}_{n} & θ {b}_{n} & φ {b}_{n}\end{matrix} ] ,$$

each row representing one point.

Next, controller 34 may assemble the raw locations of points E into map 36 (step 130). This assembly may include sub-steps. In particular, step 130 may include the sub-step of transforming the received locations of points E into coordinate system T (sub-step 150). Step 130 may also include the sub-step of applying a confidence filter to points E (sub-step 160). Additionally, step 130 may include unionizing points E received from each obstacle sensor 32 (sub-step 170).

Transforming the received locations of points E into coordinate system T (sub-step 150) may also include sub-steps. These sub-steps may be specific to each obstacle sensor, and may again be performed concurrently. For example, controller 34 may relate points E₁ in coordinate system Sa to their locations in coordinate system T. In particular, controller 34 may first relate points E₁ in coordinate system Sa in polar form to their locations in coordinate system Sa in cartesian form (sub-step 180a). The relation between coordinate system Sa in polar form (i.e. X_{SaP}) and coordinate system Sa in cartesian form (i.e. X_{Sa}) may be as follows:

$${X}_{Sa} = [ \begin{matrix}ρ {a}_{1} cos θ {a}_{1} sin ϕ {a}_{1} & ρ {a}_{1} sin θ {a}_{1} sin ϕ {a}_{1} & ρ {a}_{1} cos ϕ {a}_{1} \\ ρ {a}_{2} cos θ {a}_{2} sin ϕ {a}_{2} & ρ {a}_{2} sin θ {a}_{2} sin ϕ {a}_{2} & ρ {a}_{2} cos ϕ {a}_{2} \\ ⋮ & ⋮ & ⋮ \\ ρ {a}_{n} cos θ {a}_{n} sin θ {a}_{n} & ρ {a}_{n} sin θ {a}_{n} sin θ {a}_{n} & ρ {a}_{n} cos θ {a}_{n}\end{matrix} ] ,$$

where each row represents one point.

Next, controller 34 may relate points E₁ in coordinate system Sa in cartesian form to their locations in coordinate system T (sub-step 190a). The relation between coordinate system Sa in cartesian form and coordinate system T may be as follows:

$${X}_{T} = [ \begin{matrix}{[ {A}_{Sa} {X}_{Sa 1}^{T} + {B}_{Sa} ]}^{T} \\ {[ {A}_{Sa} {X}_{Sa 2}^{T} + {B}_{Sa} ]}^{T} \\ ⋮ \\ {[ {A}_{Sa} {X}_{San}^{T} + {B}_{Sa} ]}^{T}\end{matrix} ] , where \text{:}$$

X_{Sa}, is the first row of X_{Sa}, X_{Sa2} is the second row of X_{Sa}, and X_{San} is the nth row of X_{Sa}; A_{Sa}=A_{ysa}AₚₛₐAᵣₛₐ, and represents the rotational transform from coordinate system Sa in cartesian form to coordinate system T, where:

$${A}_{ysa} = [ \begin{matrix}cos ysa & - sin ysa & 0 \\ sin ysa & cos ysa & 0 \\ 0 & 0 & 1\end{matrix} ] ;$$

$${A}_{psa} = [ \begin{matrix}cos psa & 0 & - sin psa \\ 0 & 1 & 0 \\ sin psa & 0 & cos psa\end{matrix} ] ; and$$

$${A}_{rsa} = [ \begin{matrix}1 & 0 & 0 \\ 0 & cos rsa & - sin rsa \\ 0 & sin rsa & cos rsa\end{matrix} ] ; and$$

$${B}_{Sa} = [ \begin{matrix}{b}_{Sa 1} \\ {b}_{Sa 2} \\ {b}_{Sa 3}\end{matrix} ] ,$$

and represents the translational transform from coordinate system Sa in Cartesian form to coordinate system T.

Similarly, controller 34 may relate points E₂ in coordinate system Sb to their locations in coordinate system T. In particular, controller 34 may first relate points E₂ in coordinate system Sb in polar form to their locations in coordinate system Sb in cartesian form (sub-step 180b). The relation between coordinate system Sb in polar form (i.e. X_{SbP}) and coordinate system Sb in cartesian form (i.e. X_{Sb}) may be as follows:

$${X}_{Sb} = [ \begin{matrix}ρ {b}_{1} cos θ {b}_{1} sin ϕ {b}_{1} & ρ {b}_{1} sin θ {b}_{1} sin ϕ {b}_{1} & ρ {b}_{1} cos ϕ {b}_{1} \\ ρ {b}_{2} cos θ {b}_{2} sin ϕ {b}_{2} & ρ {b}_{2} sin θ {b}_{2} sin ϕ {b}_{2} & ρ {b}_{2} cos ϕ {b}_{2} \\ ⋮ & ⋮ & ⋮ \\ ρ {b}_{n} cos θ {b}_{n} sin θ {b}_{n} & ρ {b}_{n} sin θ {b}_{n} sin θ {b}_{n} & ρ {b}_{n} cos θ {b}_{n}\end{matrix} ] ,$$

where each row represents one point.

Next, controller 34 may relate points E₂ in coordinate system Sb in cartesian form to their locations in coordinate system T (sub-step 190b). The relation between coordinate system Sb in cartesian form and coordinate system T may be as follows:

$${X}_{T} = [ \begin{matrix}{[ {A}_{Sb} {X}_{Sb 1}^{T} + {B}_{Sb} ]}^{T} \\ {[ {A}_{Sb} {X}_{Sb 2}^{T} + {B}_{Sb} ]}^{T} \\ ⋮ \\ {[ {A}_{Sb} {X}_{Sbn}^{T} + {B}_{Sb} ]}^{T}\end{matrix} ] , where \text{:}$$

X_{Sb1} is the first row of X_{sb}, X_{Sb2} is the second row of X_{sb}, and X_{sbn} is the nth row of X_{Sb};

A_{Sb}=A_{ysb}A_{psb}A_{rsb}, and represents the rotational transform from coordinate system Sb in cartesian form to coordinate system T, where:

$${A}_{ysb} = [ \begin{matrix}cos ysb & - sin ysb & 0 \\ sin ysb & cos ysb & 0 \\ 0 & 0 & 1\end{matrix} ] ;$$

$${A}_{psb} = [ \begin{matrix}cos psb & 0 & - sin psb \\ 0 & 1 & 0 \\ sin psb & 0 & cos psb\end{matrix} ] ; and$$

$${A}_{rsb} = [ \begin{matrix}1 & 0 & 0 \\ 0 & cos rsb & - sin rsb \\ 0 & sin rsb & cos rsb\end{matrix} ] ; and$$

$${B}_{Sb} = [ \begin{matrix}{b}_{Sb 1} \\ {b}_{Sb 2} \\ {b}_{Sb 3}\end{matrix} ] ,$$

and represents the translational transform from coordinate system Sb in cartesian form to coordinate system T.

The application of a confidence filter to points E (sub-step 160) may be performed before or after step 150, and may be based upon the pairings of step 100. In particular, the received locations of points E₁ may be filtered so as to retain only those points E₁ within confidence region 44a (sub-step 160a). And, the received locations of points E₂ may be filtered so as to retain only those points E₂ within confidence region 44b (sub-step 160b). These filterings may occur concurrently, and serve to resolve conflicts between obstacle sensor 32a and 32b detections (i.e. where a conflict exists, a detection by only one obstacle sensor 32 will be retained).

After completing sub-steps 150 and 160, controller 34 may unionize transformed remaining points E₁ and E₂ (hereafter “points U”). Specifically, controller 34 may delete all points stored in map 36, and then incorporate points U into map 36. It is contemplated that by this deletion and incorporation map 36 may be kept up-to-date (i.e. only the most recent detections will be stored in map 36). It is further contemplated that controller 34 may lock map 36 after incorporating points U, thereby preventing the newly stored points U from being deleted before controller 34 determines a characteristic of an obstacle 12 (step 140).

After completing step 130, controller 34 may proceed to step 140, which may include sub-steps. In particular, step 140 may include the sub-step of applying a height filter to points U (sub-step 200). Step 140 may also include the sub-step of converting points U into obstacles 12 through blob extraction (sub-step 210). Additionally, step 140 may include the sub-step of applying a size filter to obstacles 12, thereby determining a characteristic (i.e. the size) of obstacles 12 (sub-step 220).

Controller 34 may apply a height filter to points U to filter out ground surface 37 (referring to FIG. 3) (sub-step 200). Specifically, controller 34 may filter out points U that are within a certain distance 46 (e.g. a meter) (not shown) of predicted ground surface 38 (referring to FIG. 3). This may be accomplished by comparing the spatial coordinate t₃ of each point U to a distance 48. Distance 48 may equal distance 46 subtracted from the distance between point O_{T} and predicted ground surface 38. If spatial coordinate t₃ is greater than distance 48, point U may be filtered out. But, if spatial coordinate t₃ is less than or equal to distance 48, point U may be retained.

Next, controller 34 may convert points U into obstacles 12 through blob extraction (sub-step 210). Blob extraction is well known in the art of computer graphics. Obstacles are found by clustering similar points into groups, called blobs. In particular, blob extraction works by clustering adjacent points U (indicating an obstacle 12 is present) together and treating them as a unit. Two points U are adjacent if they have either: (1) equivalent spatial coordinates t₁ and consecutive spatial coordinates t₂; (2) equivalent spatial coordinates t₁ and consecutive spatial coordinates t₃; (3) equivalent spatial coordinates t₂ and consecutive spatial coordinates t₁; (4) equivalent spatial coordinates t₂ and consecutive spatial coordinates t₃; (5) equivalent spatial coordinates t₃ and consecutive spatial coordinates t₁; or (6) equivalent spatial coordinates t₃ and consecutive spatial coordinates t₂. By converting points U into obstacles 12, obstacles 12 can be treated as individual units that are suitable for further processing.

Controller 34 may then apply a size filter to obstacles 12 (sub-step 220). Specifically, controller 34 may filter out obstacles 12 that do not have at least one of height 16, width 18, and depth 20 longer than length 22 (referring to FIG. 1). By filtering out these obstacles 12, only dangerous obstacles 12 may remain. The filtering may be accomplished by first calculating height 16, width 18, and depth 20. Height 16 may be calculated by subtracting the smallest spatial coordinate t₃ value associated with obstacle 12 from the largest spatial coordinate t₃ value associated with obstacle 12; width 18 may be calculated by subtracting the smallest spatial coordinate t₂ value associated with obstacle 12 from the largest spatial coordinate t₂ value associated with obstacle 12; and depth 20 may be calculated by subtracting the smallest spatial coordinate t₁ value associated with obstacle 12 from the largest spatial coordinate t₁ value associated with obstacle 12. Next, height 16, width 18, and depth 20 may be compared to each other. The longest of height 16, width 18, and depth 20 may then be compared to length 22. If the longest of height 16, width 18, and depth 20 is not longer than length 22, obstacle 12 may be filtered out. But, if the longest of height 16, width 18, and depth 20 is longer than length 22, obstacle 12 may be retained and classified as dangerous.

It is contemplated that after step 140, operation of the disclosed system may vary according to application. Since obstacles 12 may be dangerous, it is contemplated that the disclosed system may be incorporated into a vehicle collision avoidance system, which may warn an operator of machine 10 of dangerous obstacles 12. This incorporation may be simple and cost effective because the disclosed system need not have access to information regarding external parameters. In particular, it need not include hardware for gathering information regarding these external parameters. Alternatively, it is contemplated that the disclosed system may be incorporated into a security system. This incorporation may also be cost effective because the disclosed system may be configured with detection regions only in high threat areas such as, for example, windows and doors.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for detecting obstacles near a machine, comprising:
pairing one-to-one each of a plurality of obstacle sensors to each of a plurality of non-overlapping confidence regions;
scanning with the plurality of obstacle sensors;
receiving from the plurality of obstacle sensors raw data regarding the scanning;
assembling the raw data into a map; and
determining at least one characteristic of at least one obstacle, based on the map.

2. The method of claim 1, wherein assembling the raw data into a map includes transforming the raw data from each of the plurality of obstacle sensors into useable data.

3. The method of claim 2, wherein transforming the raw data from each of the plurality of obstacle sensors into useable data includes applying a coordinate transform specific to each of the plurality of obstacle sensors to the raw data from each of the plurality of obstacle sensors.

4. The method of claim 2, wherein transforming the raw data from each of the plurality of obstacle sensors into useable data includes applying a confidence region filter specific to each of the plurality of obstacle sensors to the raw data from each of the plurality of obstacle sensors.

5. The method of claim 2, wherein assembling the raw data into a map includes unionizing the usable data from each of the plurality of obstacle sensors.

6. The method of claim 1, wherein the map includes a sets of surface points.

7. The method of claim 6, wherein determining at least one characteristic of at least one obstacle includes determining a size of at least one obstacle.

8. The method of claim 7, wherein determining the size of at least one obstacle, includes applying a height filter to the set of surface points.

9. The method of claim 8, wherein the height filter removes a point that is within a certain distance from a predicted ground surface from the set of surface points.

10. The method of claim 7 wherein determining the size of at least one obstacle, further includes converting at least two of the surface points into at least one obstacle.

11. The method of claim 10, wherein determining the size of at least one obstacle, further includes applying a size filter to the at least one obstacle.

12. The method of claim 11, wherein the size filter retains at least one obstacle that has a height longer than a certain length.

13. The method of claim 11, wherein the size filter retains at least one obstacle that has a width longer than a certain length.

14. The method of claim 11, wherein the size filter retains at least one obstacle that has a depth longer than a certain length.

15. A system for detecting obstacles near a machine, comprising:
a plurality of obstacle sensors located on the machine; and
a controller in communication with each of the plurality of obstacle sensors, and configured to:
pair one-to-one each of the plurality of obstacle sensors to each of a plurality of non-overlapping confidence regions;
scan with the plurality of obstacle sensors;
receive from the plurality of obstacle sensors raw data regarding the scanning;
assemble the raw data into a map; and
determine at least one characteristic of at least one obstacle, based on the map.

16. The system of claim 15, wherein the map is electronic in form and stored within a memory of the controller.

17. The system of claim 16, wherein the map includes a set of surface points.

18. The system of claim 17, wherein determining at least one characteristic of at least one obstacle includes determining a size of at least one obstacle.

19. The system of claim 15, wherein the confidence regions are volumetric regions.

20. The system of claim 15, wherein assembling the raw data into a map includes transforming the raw data from each of the plurality of obstacle sensors into useable data.
